(19) United States
(12) Patent Application Publication
(10) Pub. No.: US 2002/0130940 A1
(43) Pub. Date: Sep. 19, 2002

(54) Ink jet recording apparatus

(76) Inventors: Kentaro Suzuki, Chiba-shi (JP); Hiroshige Ikeno, Chiba-shi (JP)

Correspondence Address: ADAMS & WILKS, 31st Floor, 50 Broadway, New York, NY, 10004, US

(21) Appl. No.: 10/068,834

(22) Filed: Feb. 6, 2002

(30) Foreign Application Priority Data
Mar. 8, 2001 (JP) 2001-064981

(51) Int. Cl. B41J 2/01

(52) U.S. Cl. 347/102

(57) ABSTRACT

An ink jet recording apparatus which can perform printing using ink having a high viscosity is disclosed, an ink jet recording apparatus comprising an ink jet head 11A having a plurality of nozzle openings for ejecting ink from an ink storing portions 91 and 92 is provided with: the ink storing portions 91 and 92 having radiation curable ink; and a heating devices 80A, 85A, and 95 for heating the radiation curable ink held by the ink jet head 11A, the heating device being provided at least in the vicinity of the ink jet head 11A in an ink flow path from the ink storing portions 91 and 92 to the ink jet head 11A.

### BACKGROUND OF THE INVENTION

1. Field of the Invention

The present invention relates to an ink jet recording apparatus with an ink jet head which is applied to, for example, a printer or a facsimile machine.

2. Description of the Related Art

Conventionally, screen printing is generally used when an image is printed on a surface of a recording medium such as a CD or a DVD.

According to this screen printing, an image is printed by forming different printed patterns with regard to respective colors on the surface of the recording medium using radiation curable ink such as ultraviolet curable ink or electron beam curable ink.

However, in the screen printing, since printing has to be performed a plurality of times using different plates for the respective colors, printing operation takes much time. Further, in the screen printing using plates, it is necessary to keep the plates to deal with additional prints have to be made and it is also necessary to maintain the plates, which causes a problem of high cost.

Further, an apparatus for performing the screen printing is large, and thus, there is a problem in that a large operation space is necessary and the apparatus is expensive.

These problems can be solved by printing using an ink jet recording apparatus having an ink jet head which ejects ink through a plurality of nozzles.

However, in such an ink jet recording apparatus, the viscosity of ink which can be ejected is in the range of about 5 mPa.s to about 30 mPa.s. When printing is performed on a recording medium such as a CD or a DVD using ink having such a low viscosity, the covering effect is poor, spreading of the ink and the like occur, and the print quality is insufficient. Therefore, use of radiation curable ink having a high viscosity is conceived. However, ejection of ink having a high viscosity from an ink jet recording apparatus requires the ink jet head to be driven at a high voltage for a long drive time period, which causes problems of breakage and deterioration of the durability of the ink jet head.

By adding a dilution liquid to the radiation curable ink having a high viscosity, the viscosity of the ink can be lowered to allow the ink to be ejected from the ink jet head. However, when such ink mixed with the dilution liquid is used, since the ink itself is weak, there occur problems of deterioration of the print quality due to occurrence of spreading of the ink and deterioration of the curing characteristics.

### SUMMARY OF THE INVENTION

In view of such circumstances, an object of the present invention is to provide an ink jet recording apparatus which can perform printing using ink having a high viscosity.

A first aspect of the present invention for solving the above-mentioned object is an ink jet recording apparatus comprising an ink jet head having a plurality of nozzle openings for ejecting ink from an ink storing portion, characterized by comprising: the ink storing portion having radiation curable ink; and a heating device for heating the radiation curable ink held by the ink jet head, the heating device being provided at least in the vicinity of the ink jet head in an ink flow path from the ink storing portion to the ink jet head.

A second aspect of the present invention is, in the first aspect of the present invention, an ink jet recording apparatus characterized in that the ink storing portion is an ink cartridge detachably held by a carriage together with a unit of the ink jet head and having ink therein, and the heating device is provided around an ink flow path connecting the ink cartridge and the ink jet head.

A third aspect of the present invention is, in the second aspect of the present invention, an ink jet recording apparatus characterized in that the heating device is also provided at least either in the ink cartridge or around the ink cartridge.

A fourth aspect of the present invention is, in the first aspect of the present invention, in an ink jet recording apparatus characterized in that the ink storing portion is an ink tank connected to a unit of the ink jet head through an ink supply tube forming a part of the ink flow path, and the heating device is provided around the ink supply tube.

A fifth aspect of the present invention is, in the fourth aspect of the present invention, an ink jet recording apparatus characterized in that the ink supply tube has on the midway a subtank for temporarily holding ink, and the heating device is also provided around the subtank.

A sixth aspect of the present invention is, in the fourth or fifth aspect of the present invention, an ink jet recording apparatus characterized in that the ink supply tube has on the midway an air damper for adjusting negative pressure of ink, and the heating device is also provided around the air damper.

A seventh aspect of the present invention is, in any one of the first to sixth aspects of the present invention, an ink jet recording apparatus characterized in that heating by the heating device results in an ink viscosity in the ink jet head ranging from about 5 mPa.s to about 30 mpa.s.

According to the present invention, radiation curable ink is used and the ink is heated, whereby the viscosity of the ink can be lowered to an ejectable viscosity to perform ejection and printing.

### BRIEF DESCRIPTION OF THE DRAWINGS

In the accompanying drawings:

FIG. 1 is a schematic perspective view of an ink jet recording apparatus according to Embodiment 1 of the present invention;

FIG. 2 is an exploded perspective view of an ink jet head according to Embodiment 1 of the present invention;

FIGS. 3A and 3B are an exploded perspective view and a sectional perspective view of a head chip according to Embodiment 1 of the present invention;

FIGS. 4A and 4B are schematic perspective views showing an assembly process of the ink jet head according to Embodiment 1 of the present invention;

FIGS. 5A and 5B are exploded perspective views of a head unit according to Embodiment 1 of the present invention;

FIG. 6 is an exploded perspective view of an ink cartridge according to Embodiment 1 of the present invention;

FIG. 7 is a graph showing the relationship between the temperature and the viscosity of ink according to Embodiment 1 of the present invention;

FIG. 8 is a schematic plan view of an ink jet head according to Embodiment 2 of the present invention;

FIGS. 9A and 9B are an exploded perspective view and a partial enlarged view of a head chip according to Embodiment 2 of the present invention;

FIGS. 10A and 10B are a plan view and a perspective view of a flow path substrate according to Embodiment 2 of the present invention;

FIG. 11 is a perspective view of an ink jet head according to Embodiment 3 of the present invention; and

FIG. 12 is a perspective view of a head unit according to Embodiment 3 of the present invention.

### DETAILED DESCRIPTION OF THE PREFERRED EMBODIMENTS

Hereinafter, the present invention is described in detail based on embodiments of the present invention.

Embodiment 1

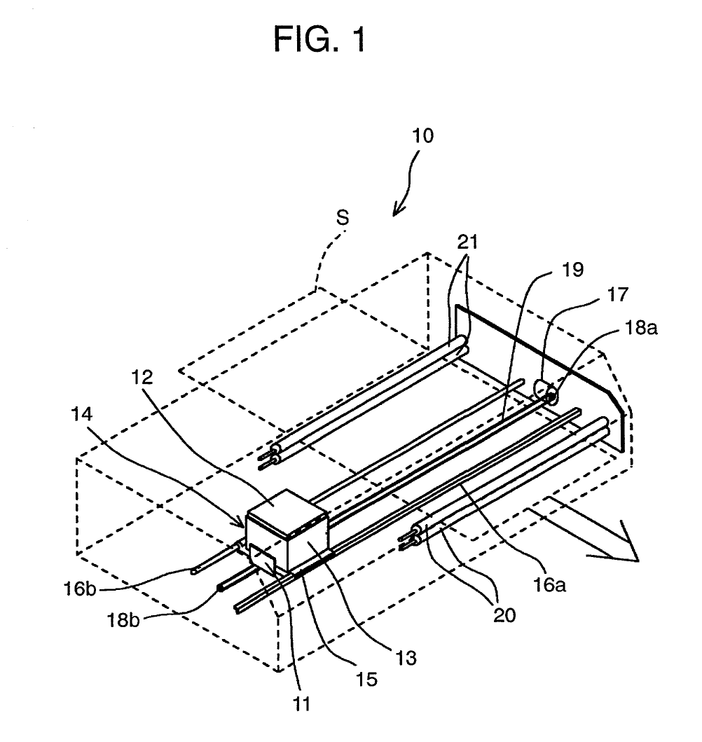

FIG. 1 is a schematic view of an ink jet recording apparatus according to Embodiment 1 of the present invention.

An ink jet recording apparatus 10 of this embodiment is a serial ink jet recording apparatus in which a head scans. As shown in FIG. 1, a head unit 14 having an ink jet head 11 for ejecting ink and a tank holder 13 for detachably holding an ink cartridge 12 for supplying ink to the ink jet head 11 through an ink flow path which is not shown is fixed to a carriage 15. The carriage 15 is axially movably mounted on a pair of guide rails 16a and 16b. A drive motor 17 is provided on one end side of the guide rails 16a and 16b such that driving force by the drive motor 17 is transmitted along a timing belt 19 pulled over a pulley 18a connected to the drive motor 17 and over a pulley 18b provided on the other end side of the guide rails 16a and 16b.

A pair of conveying rollers 20 and a pair of conveying rollers 21 are provided on end portion sides in a direction perpendicular to the conveyance direction of the carriage 15 along the guide rails 16a and 16b, respectively. These conveying rollers 20 and 21 convey a recording medium S below the carriage 15 in a direction perpendicular to the conveyance direction of the carriage 15.

By feeding the recording medium S with the conveying rollers 20 and 21 while making the carriage 15 scan in a direction perpendicular to the direction of the feeding, characters, images, and the like are recorded by the ink jet head 11 on the recording medium S.

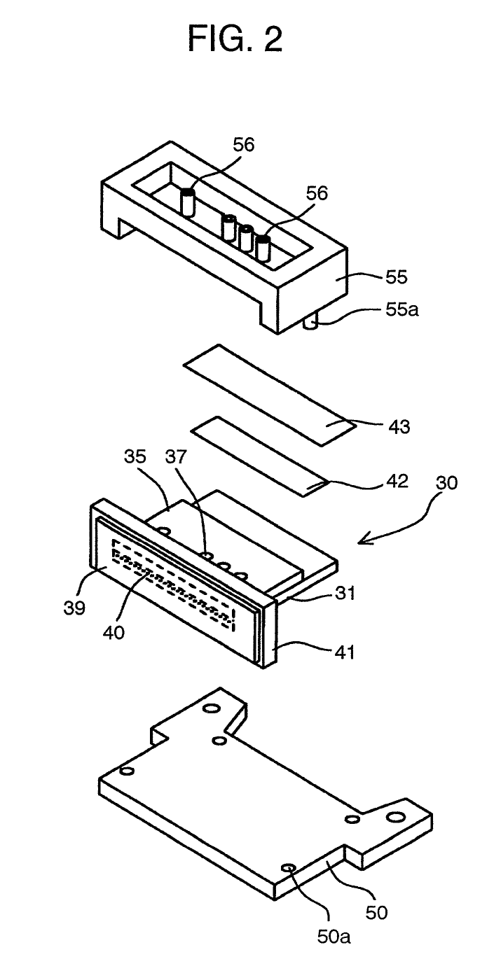

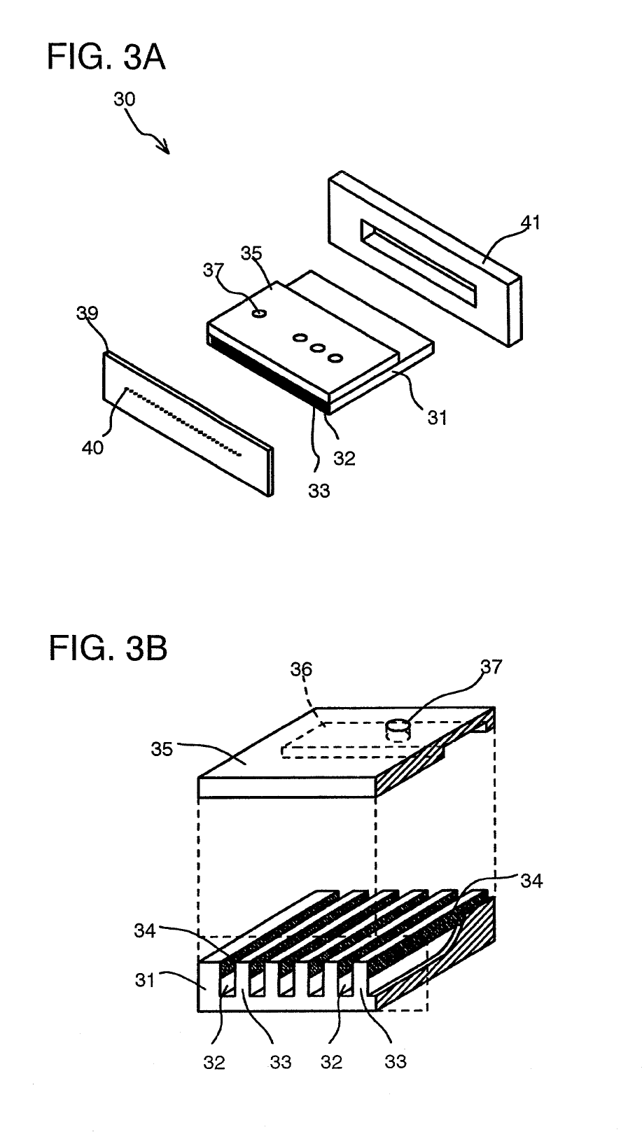

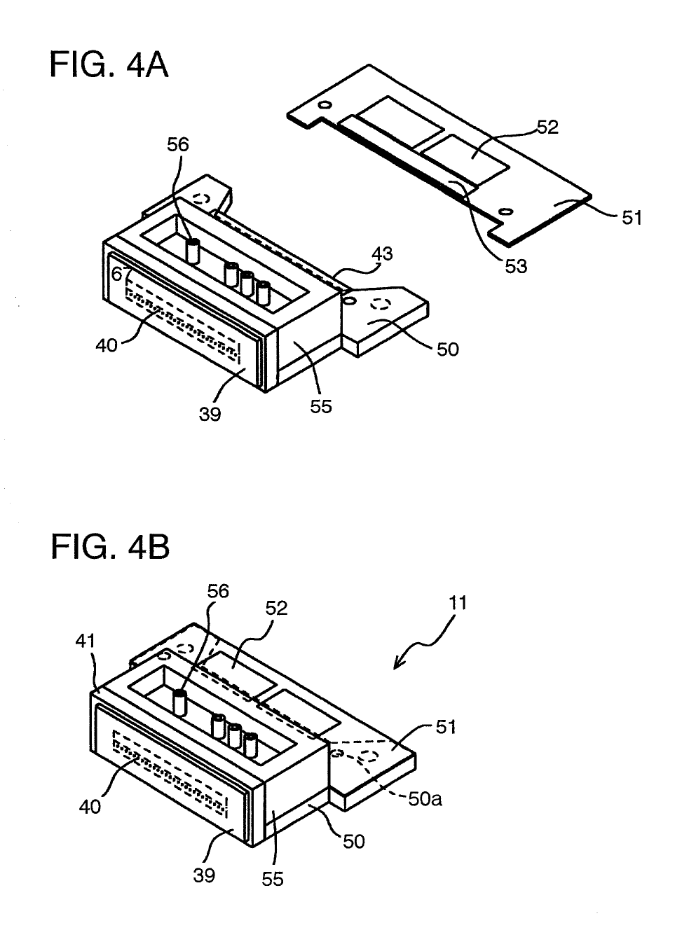

Here, an example of an ink jet head used in the ink jet recording apparatus according to this embodiment is described. It is to be noted that FIG. 2 is an exploded perspective view schematically showing the ink jet head, FIGS. 3A and 3B are perspective views schematically showing a head chip, and FIGS. 4A and 4B are schematic perspective views showing an assembly process of the ink jet head.

As shown in FIG. 2, the ink jet head 11 of this embodiment has a head chip 30, a base plate 50 which is provided on one face side of the head chip 30, and a cover plate 55 which is provided on the other face side of the head chip 30.

Here, the head chip 30 is described in detail. As shown in FIGS. 3A and 3B, a plurality of grooves 32 are provided side by side in a piezoelectric ceramic plate 31 which forms the head chip 30. The grooves 32 are separated from one another by sidewalls 33. One end portions in a longitudinal direction of the grooves 32 are provided to extend to one end face of the piezoelectric ceramic plate 31, while the other end portions do not extend to the other end face with the depth becoming gradually shallower. Further, electrodes 34 for applying a driving electric field are formed longitudinally on the opening side of the grooves 32 on the side walls 33 on both sides in the width direction of the respective grooves 32.

The grooves 32 which are formed in the piezoelectric ceramic plate 31 are, for example, formed by a disc-like dice cutter. The portions where the depth becomes gradually shallower are formed with the help of the shape of the dice cutter. The electrodes 34 formed in the grooves 32 are, for example, formed by known vapor deposition from a diagonal direction.

An ink chamber plate 35 is joined to the opening side of the grooves 32 in the piezoelectric ceramic plate 31. The ink chamber plate 35 has a common ink chamber 36 to be a concave portion communicating with the shallow other end portions of the grooves 32, and an ink supply port 37 piercing the ink chamber plate 35 from a bottom portion of the common ink chamber 36 in an opposite direction to the grooves 32.

Here, in this embodiment, the grooves 32 are divided into groups which correspond to black (B), yellow (Y), magenta (M), and cyan (C) colors, respectively, and four common ink chambers 36 and four ink supply ports 37 are provided.

It is to be noted that, though the ink chamber plate 35 can be formed of a ceramic plate, a metal plate, or the like, taking into consideration its deformation after being joined to the piezoelectric ceramic plate 31, and the like, it is preferable to use a ceramic plate having a similar coefficient of thermal expansion.

Further, a nozzle plate 39 is joined to the end face where the grooves 32 are opened in a joined body of the piezoelectric ceramic plate 31 and the ink chamber plate 35. Nozzle openings 40 are formed in the nozzle plate 39 at positions which are opposed to the grooves 32.

In this embodiment, the area of the nozzle plate 39 is larger than that of the end face where the grooves 32 are opened in the joined body of the piezoelectric ceramic plate 31 and the ink chamber plate 35. The nozzle plate 39 is a polyimide film or the like with the nozzle openings 40 formed therein using, for example, an excimer laser device. Though not shown in the figures, a water-repellant film having water repellency for preventing sticking of ink and the like is provided on a face of the nozzle plate 39 which is opposed to an object on which printing is performed.

It is to be noted that a nozzle support plate 41 is disposed around the end face where the grooves 32 are opened in the joined body of the piezoelectric ceramic plate 31 and the ink chamber plate 35. The nozzle support plate 41 is formed by being joined to the nozzle plate 39 outside the end face of the joined body and by being fitted onto and adhered to the outer face of the nozzle plate 39 and the joined body of the piezoelectric ceramic plate 31 and the ink chamber plate 35.

Further, in the head chip 30, a wiring pattern not shown which is connected to the electrodes 34 is formed at an end portion of the piezoelectric ceramic plate 31 forming the head chip 30 which is opposite to the side of the nozzle openings 40. As shown in FIG. 2, a flexible cable 43 is joined to the wiring pattern through an anisotropic electrode film 42.

Further, a base plate 50 formed of aluminum on the side of the piezoelectric ceramic plate 31 and a cover plate 55 on the side of the ink chamber plate 35 are assembled to the joined body of the piezoelectric ceramic plate 31 and the ink chamber plate 35 behind the nozzle support plate 41 to form the ink jet head 11. The base plate 50 and the cover plate 55 are fixed by engaging catching shafts 55a on the cover plate 55 into catching holes 50a in the base plate 50, and the base plate 50 and the cover plate 55 sandwich the joined body of the piezoelectric ceramic plate 31 and the ink chamber plate 35. Ink introducing paths 56 communicating with the respective ink supply ports 37 in the ink chamber plate 35 are provided in the cover plate 55.

Further, as shown in FIG. 4A, a wiring board 51 is fixedly attached onto the base plate 50 protruding on a rear end side of the piezoelectric ceramic plate 31. Here, a driver circuit 52 such as an integrated circuit for driving the head chip 30 is mounted on the wiring board 51. The driver circuit 52 is connected with the flexible cable 43 through an anisotropic electrode film 53. In this way, the ink jet head 11 shown in FIG. 4B is completed.

In the ink jet head 11, the grooves 32 are filled with ink from the ink supply ports 37 shown in FIG. 3B through the ink introducing paths 56. By making a predetermined driving electric field act on the side walls 33 on both sides of a predetermined groove 32 by the driver circuit 52 through the electrode 34, the side walls 33 are deformed to change the capacity of the predetermined groove 32, which makes ink within the groove 32 ejected from the nozzle opening 40.

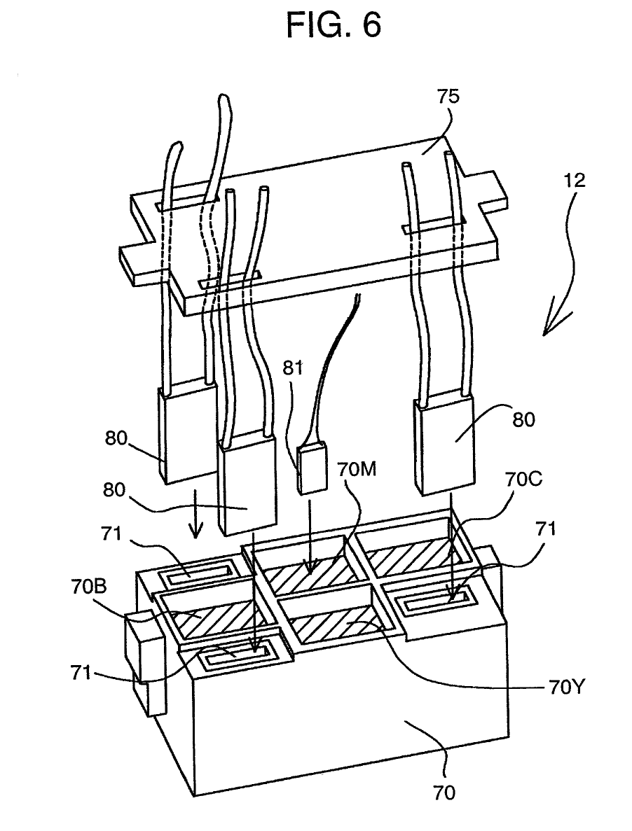

The ink jet head 11 is used by being assembled to the tank holder for detachably holding the ink cartridge 12 as shown in FIG. 6.

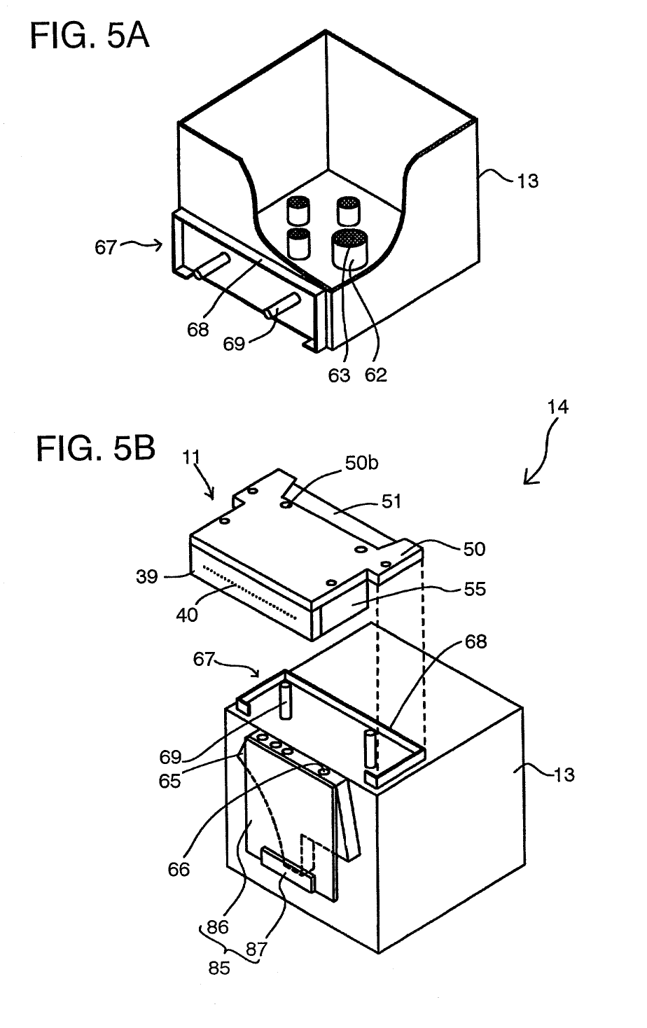

An example of such a tank holder is shown in FIGS. 5A and 5B. It is to be noted that FIG. 5B is an exploded perspective view of the head unit and FIG. 6 is an exploded perspective view of the ink cartridge.

The tank holder 13 shown in FIGS. 5A and 5B is substantially box-shaped with one face being opened such that the ink cartridge 12 is detachably held therein. Further, a connecting portion 62 for connecting with an ink supply port as an opening which is formed at the bottom of the ink cartridge 12 but which is not shown is provided on an upper face of a bottom wall of the tank holder 13. The connecting portion 62 is provided, for example, for each of black (B), yellow (Y), magenta (M), and cyan (C) color inks. An ink flow path which is not shown is formed in the connecting portion 62. A filter 63 is provided at an end of the connecting portion 62 as an opening of the ink flow path. The ink flow path formed in the connecting portion 62 is formed to communicate with a rear face side of the bottom wall. The ink flow paths communicate with head connecting ports 66 opened in a wall of a flow path substrate 65 provided on a rear face side of the tank holder 13 through not shown ink flow paths in the flow path substrate 65, respectively. The head connecting ports 66 are opened on a side face side of the tank holder 13. An ink jet head holding portion 67 for holding the above-described ink jet head 11 is provided at a bottom portion of the wall. The ink jet head holding portion 67 comprises a surrounding wall 68 provided on the base plate 50 in a standing condition so as to be substantially U-shaped to surround the driver circuit 52, and engaging shafts 69 within the surrounding wall 68 for engaging with catching holes 50b provided in the base plate 50 of the ink jet head 11.

The ink cartridge 12 held by the tank holder 13 comprises, as shown in FIG. 6, an ink cartridge body 70 with its upper portion opened, first heating devices 80 and a temperature sensor 81 both of which are provided in the ink cartridge body 70, and a lid member 75 for closing the opened upper portion of the ink cartridge body 70.

In the ink cartridge body 70, ink chambers 70B, 70Y, 70M, and 70C in which ink of black (B), yellow (Y), magenta (M), and cyan (C) colors which are radiation curable ink are absorbed in ink absorber and are held, respectively, and three heating device holding portions 71 into which the first heating devices 80 are inserted are partitioned by walls.

The first heating devices 80 inserted into the heating device holding portions 71 in the ink cartridge body 70 heat ink in the ink chambers 70B, 70Y, 70M, and 70C to a predetermined temperature. The first heating devices 80 may be, for example, ceramic heaters or the like, though they are not limited thereto.

Further, the temperature sensor 81 such as a thermistor is inserted into one of the ink chambers 70B, 70Y, 70M, and 70C, in this embodiment, into the ink chamber 70M, to detect the ink temperature in the ink chamber 70M and in the adjacent ink chambers 70B, 70Y, and 70C.

By controlling the first heating devices 80 based on the temperature detected by the temperature sensor 81, the ink temperature is made to be the predetermined temperature.

It is to be noted that, though, in this embodiment, the heating device holding portions 71 are provided in the ink cartridge body 70 and the first heating devices 80 inserted into the respective heating device holding portions 71 heat ink in the ink chambers 70B, 70Y, 70M, and 70C, the present invention is not limited thereto. For example, a plate-like member having a high thermal conductivity and a ceramic heater connected to the plate-like member may be provided on an outer peripheral face of the ink cartridge 12 such that ink is heated from outside the ink cartridge 12.

In addition, in this embodiment, by providing a second heating device 85 on an outer peripheral face of the flow path substrate 65 of the tank holder 13 as a part of the ink flow paths, ink in the ink flow paths is heated and controlled to be at the predetermined temperature.

For example, in this embodiment, the second heating device 85 is formed of a plate-like member 86 having a high thermal conductivity which is provided on the outer peripheral face of the flow path substrate 65 and a ceramic heater 87 connected to the plate-like member 86. It is to be noted that the place where the second heating device 85 is disposed, or the like is not specifically limited as far as it can heat ink in the ink flow paths.

The second heating device 85 can heat ink filled in the ink flow paths in the flow path substrate 65 to make the ink temperature the predetermined temperature.

The head unit 14 is completed by mounting the head chip 30 on the ink jet head holding portion 67 of the tank holder 13 provided with the second heating device 85. Here, the ink introducing paths 56 formed in the head cover 55 are connected to the head connecting ports 66 in the flow path substrate 65. Then, by mounting on the tank holder 13 the ink cartridge 12 provided with the first heating devices 80 shown in FIG. 6, ink introduced from the ink cartridge 12 passes through the connecting portions 62 of the tank holder 13 and through the ink flow paths in the flow path substrate 65 and is introduced into the ink introducing paths 56 of the head chip 30 to be filled in the common ink chamber 36 and in the grooves 32.

Here, ink heated by the first heating devices 80 of the ink cartridge 12 is filled in the ink jet head 11 with the ink temperature in the ink flow paths in the flow path substrate 65 being maintained by the second heating device 85.

As described in the above, the head unit 14 is mounted on the carriage 15 of the ink jet recording apparatus 10 to be used as a cartridge type ink jet recording apparatus.

Here, for the ink jet recording apparatus 10 structured in this way, radiation curable ink such as ultraviolet curable ink or electron beam curable ink having a high viscosity can be used. In this embodiment, ultraviolet curable ink of 45 mpa.s at 20° C. is used.

Normally, as the viscosity of ink ejectable from the ink jet head 11, about 5 to 30 mPa.s is optimum taking into consideration the drive voltage, drive time period, ejection speed, and the like. If the viscosity of the ink is outside this range, the ink ejection characteristics are poor, for example, the ejection speed is low. If high-voltage drive is performed in order to improve the ink ejection characteristics, the piezoelectric ceramic plate 31 may be broken or the life may be shortened. Therefore, only ink having the desired viscosity can be ejected from the ink jet head 11.

Therefore, in this embodiment, by providing the first and second heating devices, ink ejected from the ink jet head 11 is heated.

By heating ejected ink in this way, the viscosity of the ink is lowered to improve the ejection characteristics.

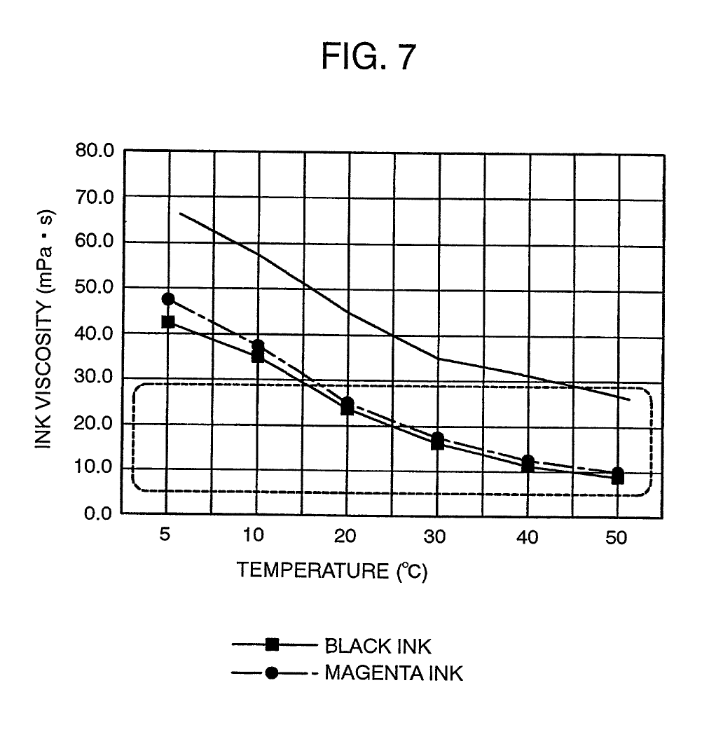

Here, the relationship between the ink viscosity and the temperature of ultraviolet curable ink is shown in FIG. 7. It is to be noted that, in FIG. 7, the ultraviolet curable ink of 45 mPa.s at 20° C. used in this embodiment is shown by a solid line. As other examples, ultraviolet curable black ink and ultraviolet curable magenta ink are shown by a solid line and a broken line, respectively. A range of viscosity of ink ejectable from the ink jet head 11 is shown by a dotted line.

As shown in the figure, in the ink temperature range of 5° C. to 15° C., the black ink and the magenta ink have the ink viscosity of 30 mPa.s or higher, which is out of the ejectable range. By heating the inks to raise the temperature to 15° C. or higher, the ink viscosity becomes 30 mPa.s or lower, and thus, ejectable.

Even in case of the ink of this embodiment having the high viscosity of 45 mPa.s with the ink temperature at 20° C., by heating the ink to about 50° C. as shown in the figure, the ink viscosity can be lowered to the ejectable viscosity of about 30 mPa.s or lower.

It is to be noted that, though, in this embodiment, the first and second heating devices 80 and 85 are provided to the ink cartridge 12 and the ink flow paths, respectively, the present invention is not limited thereto. For example, only one of them may be provided. Further, the ink jet head 11 may be separately provided with a heating device. In any case, the ejected ink is at the predetermined temperature, and thus, radiation curable ink having a high viscosity can be used, and printing can be performed using the ink jet recording apparatus 10 on a recording medium such as a CD or a DVD on which printing is conventionally performed by screen printing. Further, in printing using the ink jet recording apparatus 10, the ink ejection characteristics, the ink cure characteristics, and the print quality can be improved. Still further, printing using radiation curable ink can be performed with the space being saved and with the cost being lowered.

Embodiment 2

In the above-described Embodiment 1, the cartridge type ink jet recording apparatus 10 comprising the small-sized ink jet head 11 with the ink cartridge 12 being mounted as an ink storing portion is illustrated. Embodiment 2 illustrates a fixed-head ink jet recording apparatus using a large line-type ink jet head.

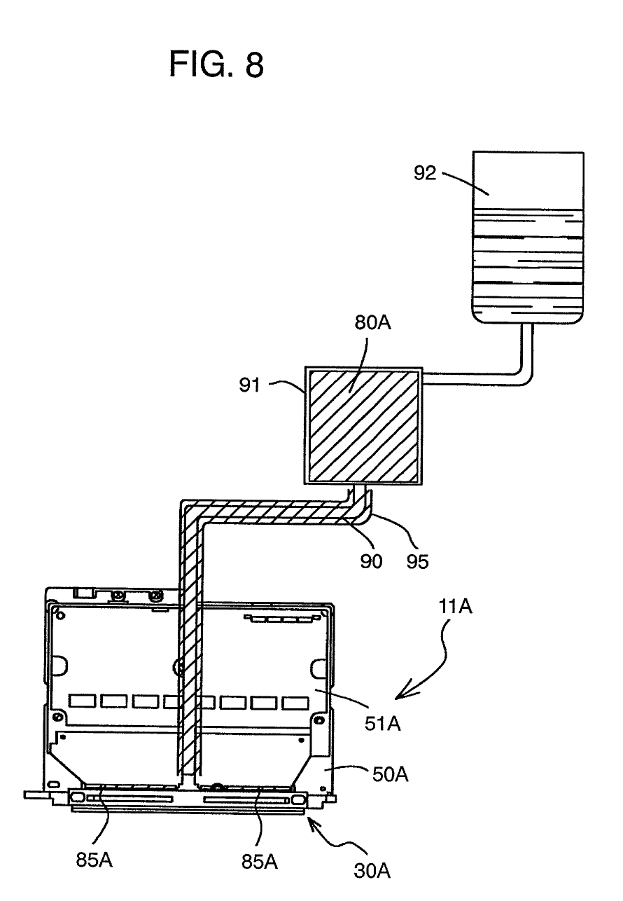

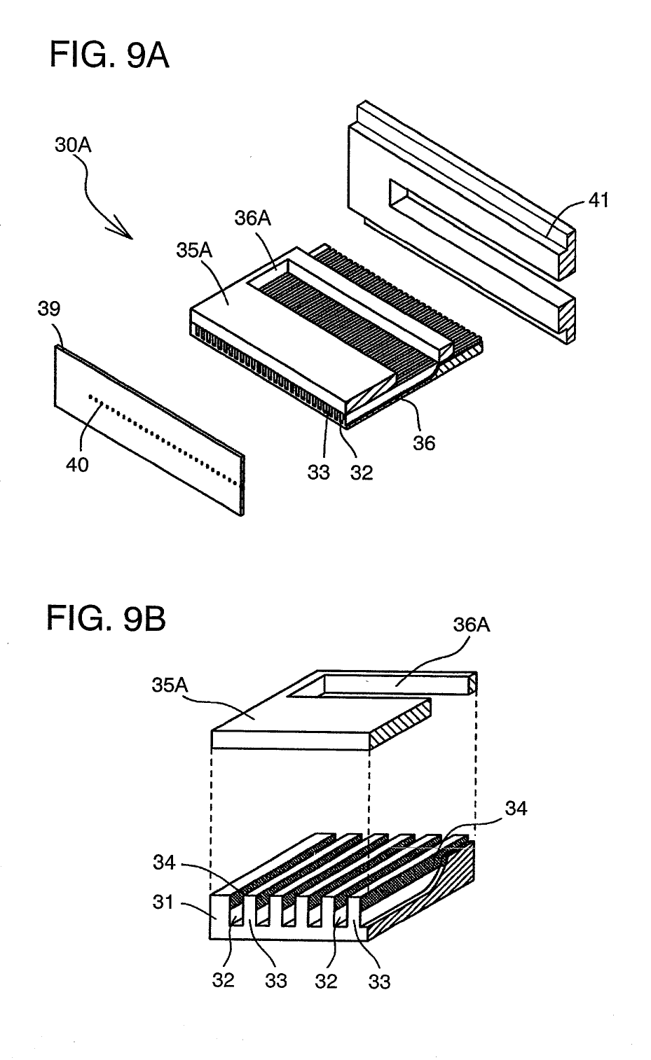

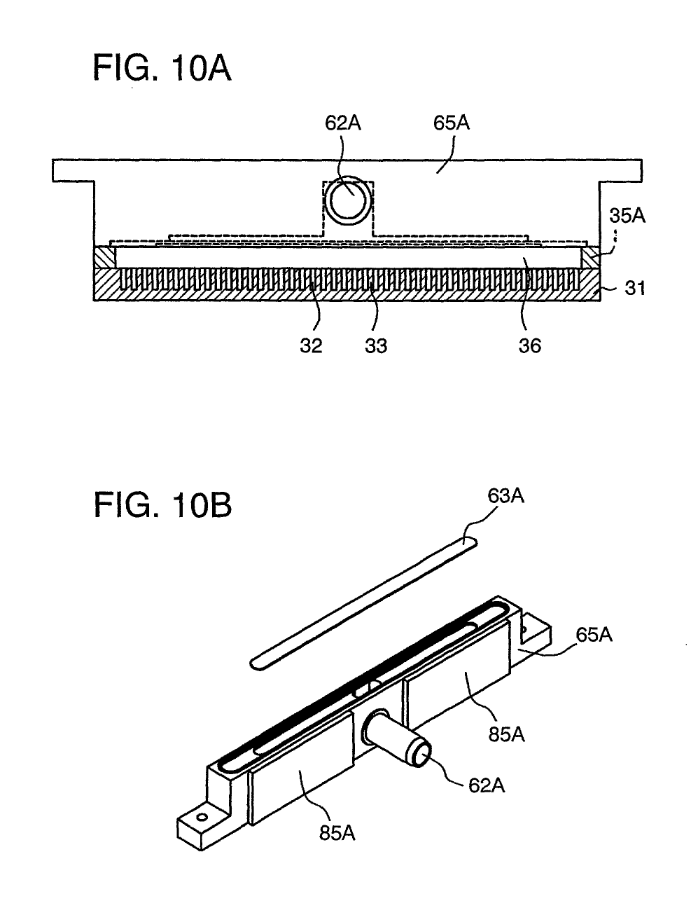

FIG. 8 is a schematic plan view of an ink jet head and an ink tank in accordance with Embodiment 2. FIGS. 9A and 9B are perspective views of a head chip forming the ink jet head. FIGS. 10A and 10B are a plan view and a perspective view of a flow path substrate.

As illustrated in the figures, an ink jet head 11A of this embodiment has a head chip 30A, a flow path substrate 65A provided on its one face side, and a wiring substrate 51A having a driver circuit for driving the head chip 30A and the like mounted thereon. These members are fixed to a base plate 50A.

Similarly to the case of the above-described Embodiment 1, the head chip 30A comprises a piezoelectric ceramic plate 31, a nozzle plate 39, a nozzle support plate 41, and an ink chamber plate 35A. The ink chamber plate 35A is provided with a piercingly formed common ink chamber 36A over the whole grooves 32 which are provided side by side.

Further, the flow path substrate 65A as shown in FIG. 10A is joined to one face of the ink chamber plate 35A. One face of the common ink chamber 36A is sealed by the flow path substrate 65A. More specifically, the flow path substrate 65A is, for example, in contact with the one face of the ink chamber plate 35A through an O-ring or the like, and is fixed to the base plate 50A by screw members or the like which are not shown.

Further, a connecting portion 62A to which an ink supply tube 90 formed of a stainless steel tube etc. is connected is formed on an upper face of the flow path substrate 65A. A subtank 91 is connected to the other end of the ink supply tube 90 one end of which is connected to the connecting portion 62A. An ink tank 92 is connected to the subtank 91 to form the ink storing portion.

In this way, ink from the ink tank 92 is temporarily held in the subtank 91, and after that, is supplied to the head chip 30A through the ink supply tube 90 and the flow path substrate 65A.

Further, second heating devices 85A for heating ink in the ink flow paths which are not shown in the figures but which are in the flow path substrate 65A, and in the common ink chamber 36A and the grooves 32 in the head chip 30A are provided on the upper face of the flow path substrate 65A.

It is to be noted that, since the ink jet head 11A of this embodiment is large, ink used in printing is consumed rapidly, ink in the ink flow paths and in the head chip 30A is ejected immediately, and thus, ink can not be sufficiently heated to a predetermined temperature only by the second heating devices 85A. Therefore, in this embodiment, first and third heating devices 80A and 95 are provided at the subtank 91 and the ink supply tube 90, respectively. Since the first and third heating devices 80A and 95 heat ink in the subtank 91 and ink in the ink supply tube 90, ink at a sufficiently high temperature can be ejected even with a large ink jet head which rapidly consumes ink.

It is to be noted that the first heating device 80A may be provided in the subtank 91 similarly to the case of the first heating devices 80 provided in the ink cartridge 12 of the above-described Embodiment 1. Alternatively, the first heating device 80A may be provided on the outer peripheral face. With regard to the third heating device 95, though it is provided around the ink supply tube 90 in this embodiment, it may be provided in the ink supply tube 90, for example, through passing a heat-dissipating wire. In any case, the first and third heating devices 80A and 95 are not specifically limited as far as they can heat ink.

The ink jet head 11A or a plurality of the ink jet heads 11A structured in this way are fixed in a main scanning direction, and are used as a line-type fixed-head ink jet recording apparatus or the like which performs printing by moving a recording medium in a sub-scanning direction and ejecting ink from desired nozzle openings 40.

In this way, according to this embodiment, ink in the flow path substrate 65A, the head chip 30A, the subtank 91, and the ink supply tube 90 can be heated to a predetermined temperature without fail by the first, second, and third heating devices 80A, 85A, and 95 and can be ejected. This improves the ink ejection characteristics, the ink cure characteristics, and the print quality to make it possible to perform printing on a recording medium such as a CD or a DVD.

It is to be noted that, though, in this embodiment, the subtank 91 is provided between the head chip 30A and the ink tank 92, and the subtank 91 and the ink supply tube 90 are heated, the present invention is not limited thereto. For example, the subtank may not be provided and the ink tank 92 may be directly heated. However, if the whole ink in the ink tank 92 is heated, as the ink is used, the remaining ink is heated for a long time, and thus, there is a fear that the life of the radiation curable ink may be shortened.

Embodiment 3

In the above-described Embodiment 2, the fixed-head ink jet recording apparatus using the large line-type ink jet head is illustrated. Embodiment 3 illustrates an ink jet recording apparatus of a serial-type or the like using a large ink jet head.

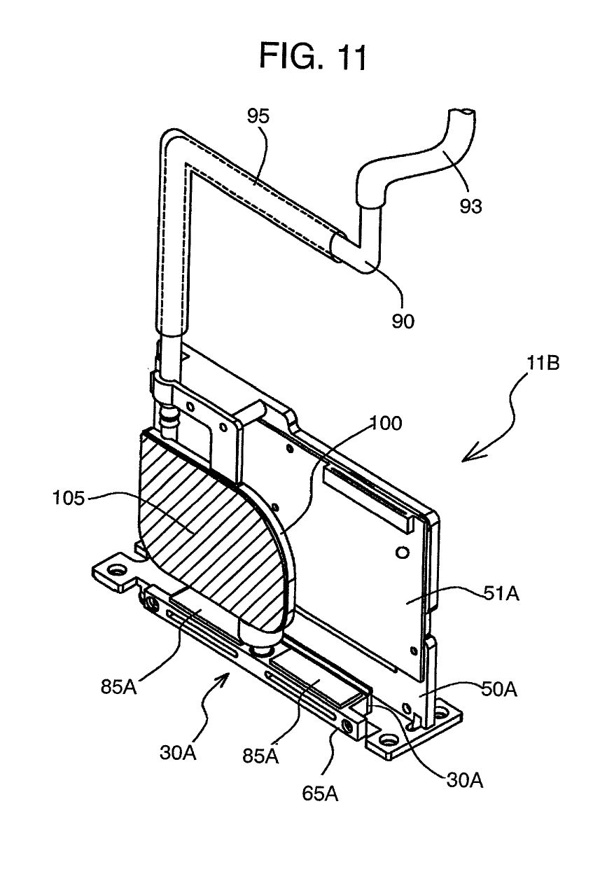

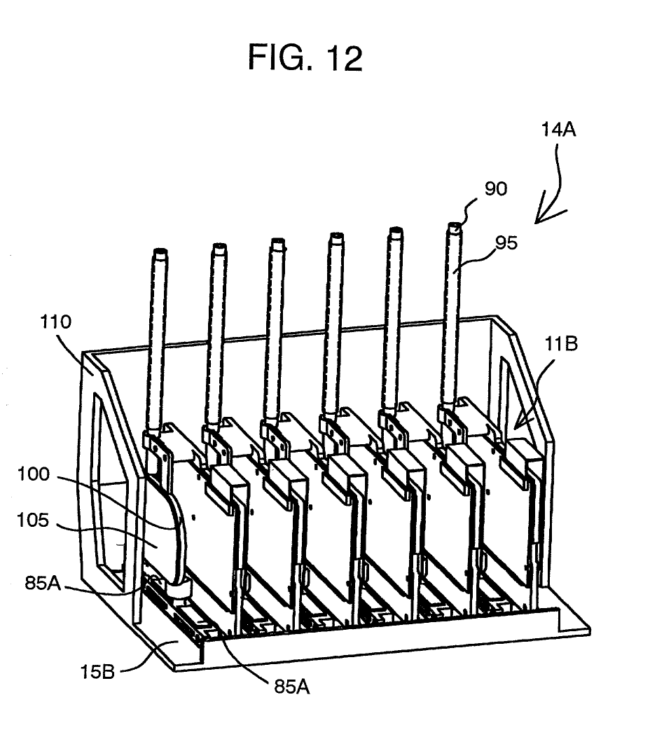

FIG. 11 is a perspective view of an ink jet head in accordance with Embodiment 3, and FIG. 12 is a perspective view of a head unit.

As shown in FIGS. 11 and 12, in an ink jet head 11B of this embodiment, an air damper 100 held by a base plate 50A is provided between an ink supply tube 90 and a flow path substrate 65A. To form a head unit 14A, a plurality of the ink jet heads 11B are mounted in a main scanning direction on a carriage 110 which is provided so as to be movable in the main scanning direction. The structure is similar to that of the above-described Embodiment 2 except that an ink tank which is not shown in the figures is connected through a flexible tube 93 formed of rubber, plastic, or the like to a side of the ink supply tube 90 which is opposite to the side where the air damper 100 is provided.

In this embodiment, similarly to the case of Embodiment 2 described above, a second heating device 85A is provided on the flow path substrate 65A of the head chip 30A, while a third heating device 95 is provided around the ink supply tube 90.

The air damper 100 adjusts negative pressure of ink supplied when the ink jet head 11B is moved in the main scanning direction. In this embodiment, a fourth heating device 105 is provided in or around the air damper 100.

In this way, also with regard to a serial-type ink jet recording apparatus, ink can be heated to a predetermined temperature by providing the second, third, and fourth heating devices 85A, 95, and 105 at the flow path substrate 65A, the head chip 30A, the ink supply tube 90, and the air damper 100, respectively. This can improve the ink ejection characteristics, the ink cure characteristics, and the print quality of radiation curable ink having a high viscosity to be used.

It is to be noted that, similarly to the above-described embodiment, the head chip 30A of this embodiment may be provided with a subtank 91 and an ink tank 92, and a first heating device 80A for heating the subtank 91 may be provided.

Other Embodiments

Embodiments 1 to 3 of the present invention are described in the above, though the ink jet recording apparatus of the present invention is not limited to these structures.

For example, in the above-described Embodiments 1 to 3, the xaar type ink jet heads 11, 11A, and 11B are illustrated, but the present invention is not limited thereto. It goes without saying that the present invention can be applied to ink jet heads of various structures such as a bubble jet type ink jet head.

Further, though, in the above-described Embodiments 1 to 3, the heating devices 80, 80A, 85, 85A, 95, and 105 are illustrated, the shapes of the heating devices, the places where the heating devices are disposed, and the like are not specifically limited as far as the ink temperature when the ink is ejected can be controlled to be at a predetermined temperature. The ink jet head itself may be heated by an external heater or the like. In this way, by heating ink when ejected to a predetermined temperature and lowering the viscosity up to an ejectable range, radiation curable ink having a high viscosity can be used, and the ink ejection characteristics, the ink cure characteristics, and the print quality can be improved.

As described in the above, according to the present invention, by using radiation curable ink and providing a heating device for heating the radiation curable ink at least in the vicinity of an ink jet head in an ink flow path, the viscosity of the radiation curable ink when ejected from the ink jet head can be easily lowered, and the ejection characteristics and the cure characteristics of the ink can be improved to improve the print quality. Further, by using radiation curable ink in this way, printing can be performed on a recording medium such as a CD or a DVD on which it is difficult to perform printing using conventional ink, with the space being saved and with the cost being lowered.

What is claimed is:

1. An ink jet recording apparatus comprising:
an ink storing portion having radiation curable ink; an ink jet head having a plurality of nozzle openings for ejecting ink from the ink storing portion; and a heating device for heating the radiation curable ink held by the ink jet head, the heating device being provided at least in the vicinity of the ink jet head in an ink flow path from the ink storing portion to the ink jet head.

2. An ink jet recording apparatus according to claim 1, wherein the ink storing portion is an ink cartridge detachably held by a carriage together with a unit of the ink jet head and having ink therein, and the heating device is provided around an ink flow path connecting the ink cartridge and the ink jet head.

3. An ink jet recording apparatus according to claim 2, wherein the heating device is also provided at least either in the ink cartridge or around the ink cartridge.

4. An ink jet recording apparatus according to claim 1, wherein the ink storing portion is an ink tank connected to a unit of the ink jet head through an ink supply tube forming a part of the ink flow path, and the heating device is provided around the ink supply tube.

5. An ink jet recording apparatus according to claim 4, wherein the ink supply tube has on the midway a subtank for temporarily holding ink, and the heating device is also provided around the subtank.

6. An ink jet recording apparatus according to claim 4, wherein the ink supply tube has on the midway an air damper for adjusting negative pressure of ink, and the heating device is also provided around the air damper.

7. An ink jet recording apparatus according to claim 1, wherein heating by the heating device results in an ink viscosity in the ink jet head ranging from about 5 mPa.s to about 30 mPa.s.
